(19) United States
(12) Patent Application Publication
(10) Pub. No.: US 2011/0039239 A1
(43) Pub. Date: Feb. 17, 2011

(54) Motivational, inspirational apparatus, aka; motivational gizmo

(76) Inventor: Robin Lloyd Futoran, Studio City, CA (US)

Correspondence Address: Dr. Robin L. Futoran, 12440 Moorpark Street, Studio City, CA, 91604, US

(21) Appl. No.: 12/583,206

(22) Filed: Aug. 17, 2009

(51) Int. Cl. G09B 19/00

(52) U.S. Cl. 434/238; 434/430

(57) ABSTRACT

A motivational, inspirational apparatus that is both functional and decorative. Has a base varying is size, shape and composition, with one step. Multiple holes at equal distance are placed on the top of the base. Posts of varying materials are inserted into the holes on top of the base. Tops of varying shapes, materials and textures are placed atop the posts and rotate 360 degrees. When placed atop the posts they look like a lollipop or ping pong paddle. Stickers of varying materials are with specific motivational and inspirational words related to actions, projects, and life situations are adhered to the tops for daily inspirational and motivational reference. When actions are accomplished, the top is turned 180 degrees. In the morning, all tops are again turned with the event words facing forward to address each action in the new day.

### FIELD OF THE INVENTION

The present invention relates to motivational devices and, more particularly, a tool to focus one's attention on important daily tasks and responsibilities in order to achieve long term desired, purposeful lifetime aims and objectives.

### BACKGROUND OF THE INVENTION

With an ever increasing overload of information, activities and over stimulation in so many forms, there has been need for an instrument that could focus and prioritize one's attention and actions on important needs and desires.

In ancient times, philosophers, scientists, mathematicians and astronomers had few distractions and great amounts of time to think, study, learn and create. This allowed for significant numbers of new discoveries, inventions and new technologies that we continue to use in present times.

In this modern highly technological age people are overloaded and distracted with volumes of work, family, friends, televisions, radio, MP3, DVD, sports, games, electronic games, surfing the web, shopping, socializing, cell phones, text messaging, emailing, faxing, cars, commercials, commutes, cooking, eating, homework, chores, charity, organizations, professional boards, travel, hobbies, collections, and other such activities. There seems to be an unending stream of stimulation, information, and entertainment filling every moment from morning to night with little time to think let alone complete personal goals, projects and to create big dreams. At the end of a full day, most people avoid creative, productive thinking and activities.

Many people feel they do not have the ability to focus on and to complete important tasks and projects. Because of this, society often determines the problem to be a medical condition and turn to medication in an effort to focus one's attention of important projects and life tasks. People and society loose opportunities for new ideas and one's self esteem can be reduced by not following a creative or productive desire.

Most people do have multiple creative ideas or endeavors they would like to develop or complete. A new invention, a product to develop and manufacture, a new business concept, a life project, career goals, relationship goals, ideas to write books, purchase a home, stop addictive behavior, spiritual growth, weight loss, an education goal, over coming an obstacle, financial goals. With so many great ideas and big dreams, few are ever accomplished due to the easily available distractions that fill and entertain most of one's life.

As in history, modern inventors, scientists and leaders are phenomenally and unconsciously driven to create what they've done in their lives. Not only are people like Leonardo Da Vinci, Thomas Edison, Albert Einstein, Ben Franklin, Marie Curie, Henry Ford, Steven Jobs to name few of thousands great thinkers, but the have the ability to follow through to the end of an idea. The average person though having unique, interesting ideas and desires fail to even attempt developing their idea let alone follow through to completion of those concepts.

This lack in ability to follow through and accomplish creative goals, ideas, and endeavors as a result of life's overload and over stimulation proves the need for an apparatus that focuses people on the important tasks and goals.

There are fortunes made in course upon course that teach how to follow through with an idea or desire to its completion. Anthony Robbins and Donald Trump teach courses on how to successfully start a business or purchase property. Trade school exist specifically teaching step by step concepts to achieve career or investment goals. It is human nature to have creative ideas and to bring them to fruition.

A need persists for a personal inspirational and motivational tool that focuses peoples attention on the most important objectives in reaching their necessary and desired goals. Achieving one's goals and desires creates the highest of self esteem and joy in one's life.

It is long over to that a simple, portable, cost effective device be made available to motivate everyone towards having a consistent awareness of working towards their specific and personal goals and dreams. A simple, visual and interactive tool present to prompt thoughts, ideas and actions each day in moving towards important gratifying personal accomplishments.

Though not designed with the same intent or context as this design, there have been and are currently visual reminders in stationary stores and gift stores in the form of cards, placards, posters and calendars. They are checklists, pages with paper tags to lift and writing on paper forms. Additionally, there are computer software reminder calendars and programs for daily tasks. Though not found available for purchase, other patents were found as visual reminders including; U.S. Pat. No. 3,916,547 issued Nov. 4, 1975 to Francis E. Ryder called a VISUAL REMINDER DEVICE, U.S. Pat. No. 3,693,580 issued Sep. 26, 1972 to Walther Thierer called MEMORY BOARD, U.S. Pat. No. 3,290,796 issued Dec. 13, 1966 to R. J Gurda titled CONTROL APPARATUS, U.S. Pat. No. 4,776,799 issued Oct. 11, 1988 to Susan M. Walsh titled PORTABLE, SELF-CONTAINED EDUCATIONAL-ORGANIZATIONAL SYSTEM AND METHOD EMPLOYING SUCH SYSTEM, U.S. Pat. No. 5,577,915 issued Nov. 26, 1996 to Dana H. Feldman and titled MOTIVATIONAL TASK TRACKING DEVICE, U.S. Pat. No. 4,741,701 issued May 3, 1988 to Steven A. Kossor called APPARATUS FOR PROVIDING VISUAL FEEDBACK CONCERNING BEHAVIOR, D484,827 issued Jan. 6, 2004 to Merle Reuser titled MOTIVATIONAL DISPLAY.

The previously noted solutions highly differ in their intent. Most of these patent designs are simple or complex TO-DO LISTS. They are simple reminders of daily tasks for kids and adults such as washing hands, taking out trash, bathing, brushing teeth, turn lights on or off, grocery shopping list, cleaning one's room, chores and homework, or caring for a pet. Some are behavior modification devices as reminders to act in appropriate ways. Several of them are highly complex in tracking daily activities with special codes and include rewards for completed tasks.

No other current approach offers a simple, cost effective device created specifically to Inspire and Motivate people in focusing on and accomplishing daily actions that will lead to achievement of their highest goals, dreams and accomplishments. None of the devices are currently for centering one's intentions and daily practice on specific, personal achievements and accomplishments.

### SUMMARY OF THE INVENTION

In accordance with the present invention, there is provided a motivational, inspirational apparatus that is both functional and decorative. A flat, smooth, rectangular base similar in shape to a shoe box top, with one step at half its depth. The base may also be round, arched, or other shapes. The base itself is light weight, dense foam rubber, wood, metal, stone or other material. Three to four holes are placed at equal distances on each of the two steps on top of the base, totaling six to eight holes in two rows. Six to eight cylindrical posts similar in shape to a thick pencil body, fit into the holes on top of the base. The posts may be acrylic, wood, rubber, metal or other materials and are fixed in an upright position. Six to eight smooth round tops are placed on their edge atop each of the posts. Tops themselves are flat, hollow circles similar in shape to a round drink-coaster. When placed atop the posts they look like a lollipop or ping pong paddle. The Tops are cardboard though may be wood, metal, plastic or other material and may vary in shape. The tops turn 360 degrees on the posts. Stickers are included with specific words related to actions, projects, motivation, inspiration and blanks for specialized, custom and personally written words. Stickers may be paper, plastic, or other materials. Appropriately worded stickers are placed on the face of each paddle for daily inspirational and motivational reference. When actions are accomplished, the top is turned 180 degrees. In the morning, all tops are again turned with the event words facing forward to address each action in the new day.

It would be advantageous to provide a device that motivates and inspires people to meet essential commitments, accomplish important life deeds and to achieve personal objectives,

It would also be advantageous to provide a decorative reminder of one's desires and life goals.

It would further be advantageous to provide support in moving past life's obstacles in successfully handling difficult situations.

It would also be advantageous to provide an apparatus to conquer additions, find a worthy relationship, or bring about optimal heath.

It would further be advantageous to provide a method to start a business, increase productivity, increase knowledge, develop a new product, loose weight and improve relationships.

Finally it would be advantageous rather than to live in a world of senseless distraction, be able to focus one's attention and energy on addressing productive needs and accomplishing personal desires.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of a referenced motivational, inspirational apparatus constructed in accordance with the principles of this invention;

FIG. 2 is a right detail view of the motivational inspirational apparatus showing 2-1, 2-2 the base with two steps, 2-4 posts placed in the top of holes in the base and 2-5 tops mounted on the posts;

FIG. 3 is a perspective view of a motivational, inspirational apparatus exhibiting 3-1, 3-2 the base with two steps, 3-4 the posts inserted into holes in the top of the base, though not limited to six, 3-5 tops not limited to six;

FIG. 4 is an exploded view of a perspective view of the motivational, inspirational apparatus further showing the 4-3 holes in the top of the 4-1, 4-2 base for insertion of the 4-4 posts with mounted 4-5 tops; and

FIG. 5 is a perspective view of the motivational, inspirational apparatus is an example of a plan with more than six posts and tops. the apparatus could further have more than one step and more or less than six posts with tops.

For purposes of clarity and brevity, like elements and components will bear the same designations and numbering throughout the Figures.

### DESCRIPTION OF THE PREFERRED EMBODIMENT

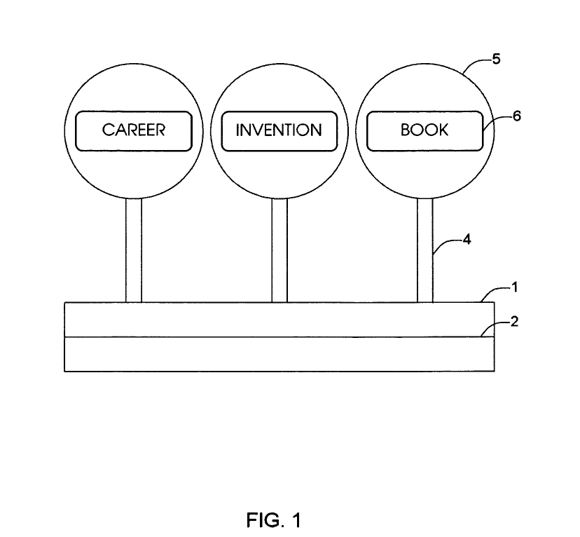

FIG. 1 is a front view of referenced motivational, inspirational apparatus constructed in accordance with the principles of this invention.

Numbers 1 and 2 represent the base 10. The base 10 my consist of a single piece or multiple pieces. Of the base 10 components, numbers 1 and 2 further represent steps as part of the base 10. 1 being the top step of the base 10 and 2 being the lower step of the base 10. The steps 1,2 are equal in width and equal in height, while the depth of the top step, 1 is one half the depth of the base 10 and equal in depth to the lower step 2. Together the steps 1 and 2 comprise a rectangular shaped base 10 when looking from above. There is no limit as to the size of the base 10 and components.

Additionally, the base 10 numbers 1 and 2, as it sets on a flat surface might be flat, convex, dome shaped, arched, angled, or concave. Looking down on the base 10 from above, it may be rectangular, round, square, triangular, oval, oblong, puzzle piece shaped, irregular or creative shapes in the form of animals, planets, modes of transportation, landscape featured or any other suitable shape. The bottom of the base 10 may consist of a non-skid surface of rubber, felt, plastic, wood or other suitable material.

The base 10 1,2 is decorative and functional. It is the location of holes on its top to accept the posts 12 to be further described. It will also have space to mount stickers 16, or plaques with motivational words, quotes, phrases and sayings.

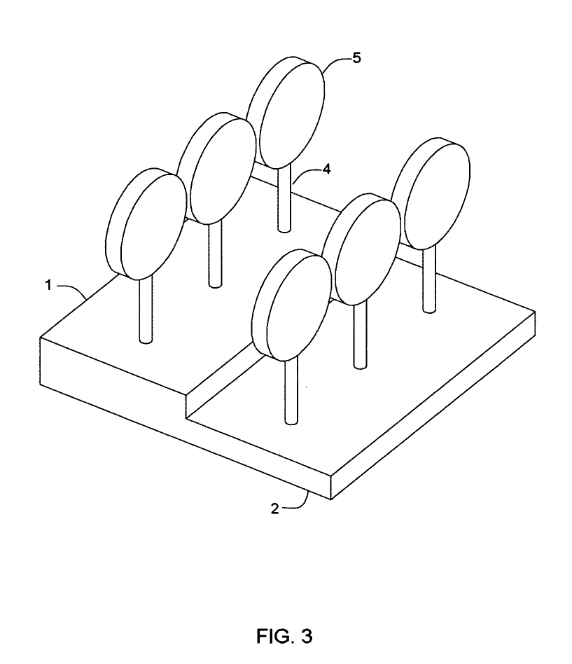

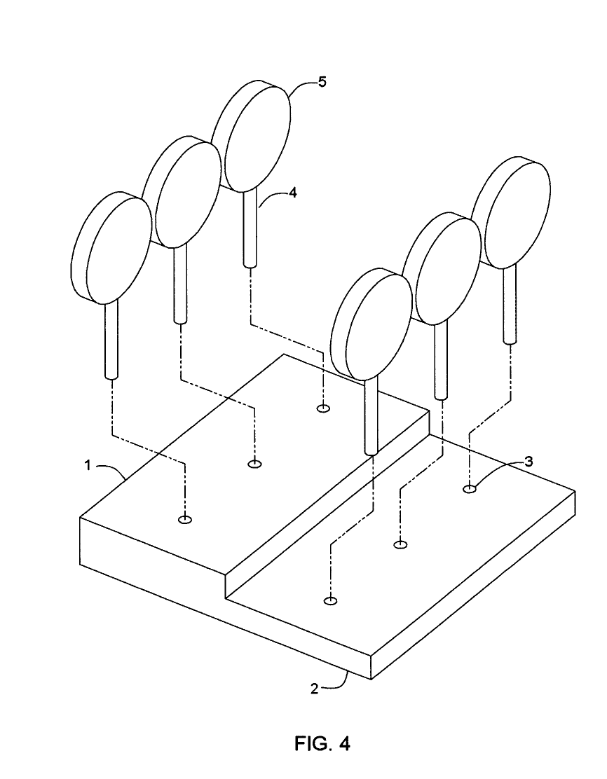

Holes in the top of the base 10 1,2 which will accept the posts 12 numbered 4, viewed best in FIG. 4-3 may be smooth, textured, have threads, be a slit in foam rubber, cylindrical, conical or round.

The base 10 numbers 1 and 2 may be made of wood, plastic, metal, pewter, silver, gold, brass, bronze, stone, composite, foam, rubber, mesh, clay, glass, recycled products, paper or any other suitable material. The base 10 may any color. The base 10 may be solid or permeable. On the top of the base 10 are holes, indentations, mesh, holders or other features that accept multiple and various types of posts 12 numbered 4 in all figures.

The posts 12 numbered 4, to fit into the top of the base 10 1,2, might be cylindrical like a pencil, round, square, or triangular. The bottom end of the post 4 will be a shape to fit firmly into the holes in the top of base 10 1,2. The bottom of the post 4 may be smooth, textured, have threads, a point or a ball so that it may snap-in, screw-in, set-in or be glued into the base 10 1,2. Once the bottom of the post 4 is inserted into the top of the base 10 1,2, the top end of the post 4 will then accept the motivational apparatus tops 14 numbered 5 in the drawings. The top of the post 4 may be smooth, textured, threaded or any other suitable surface to accept the tops 14 5. The top of the post 4 will be a shape that allows 360 degree turning of the tops 14 5.

The posts 12 4 will be fixed and firm. The post 4 will be made of wood, plastic, metal, pewter, silver, gold, brass, bronze, stone, composite, foam, rubber, mesh, clay, glass, recycled products, paper or other suitable material. The posts 12 4 might be any color. There may be an indented space on the post 4 to place a sticker or plaque containing a motivational word or phrase.

The posts 12 4 may varying in height. Though the drawings show six and eight posts 12 4, there may be many more or less in number.

Tops 14 numbered 5 in each drawing are designed to be placed atop the posts 12 4. The tops 14 5 might be round, square, half circle, dome shaped, triangular, rectangular, concave, convex, arched, sail shaped, circular, flat, star and planet shaped, half moon, boat, animals, rainbow, plants, flowers, cars, furniture, books, buildings, musical instruments, musical notes, pots and pans, sea creatures, fruit, vegetables, birds or other varieties of shapes. The tops 14 5 may be smooth or textured. Tops 14 5 may be composed of wood, plastic, metal, pewter, silver, gold, brass, bronze, stone, composite, foam, rubber, mesh, clay, glass, recycled products, paper or other suitable materials. The tops 14 5 may be solid, firm or flexible.

There may be an indentation, smooth area, sign plate, plaque or other demarcated foci on the tops 14 5 for placement of stickers 16 6. The tops 14 5 are the primary location for motivational, inspirational word headings and phases.

As with the posts 12 4, drawings show either six or eight tops 14 5, while there may be many more or even fewer. Posts 12 4, and tops 14 5, are positioned at equal distances apart on the base 10 1,2, avoiding the tops 14 5 touching while able to turn 360 degrees.

Stickers 16 numbered 6 in all drawings might be made of paper, plastic, rubber, metal, wood or other suitable material. The stickers 16 6 might be any color. Shapes of stickers 16 6 will vary and could be round, square, half circle, dome shaped, triangular, rectangular, concave, convex, arched, sail shaped, circular, flat, star or planet shaped, half moon, boat, animals, rainbows, plants, flowers, cars, furniture, books, buildings, musical instruments, musical notes, pots and pans, sea creatures, fruit, vegetables, or birds.

These stickers 16 6 are designed to be placed on the tops 14 5 including a possible demarcated space on the tops 14 5.

On the stickers 16 6 will be motivational, inspirational words, sayings, phrases and quotes. Also included will be blank stickers 16 for personalization and custom, individually written words, headings or sayings. There will be no limit to the number of languages for which the words, sayings, phrases and quotes are printed.

Motivational, inspirational words, quotes, sayings phrases and headings will include but are not limited to; work related subjects as; work, career, job, gratitude, action, school, new project, goal, quota; Health related subjects as; health, exercise, nutrition, sugar, diet, relationship related subjects as; relationships, love, family, parents, brother, sister, kids, friends, joy, divorce, marriage, financial subjects as; financial order, investments, stocks, taxes, independence, abundance, prosperity, project development subjects as; project, invention, book, new business, letters, phone calls, manufacturing, baking, subjects of desire like; joy peace, harmony, love, abundance, prosperity, gratitude, healing, house, car, boat, truck, snowmobile, motorcycle, Aston martin, Ferrari, other vehicles, vacation, travel, jewelry, marriage, kids, faith, live in the moment, heaven, music, band, instrument, concert, and meditation.

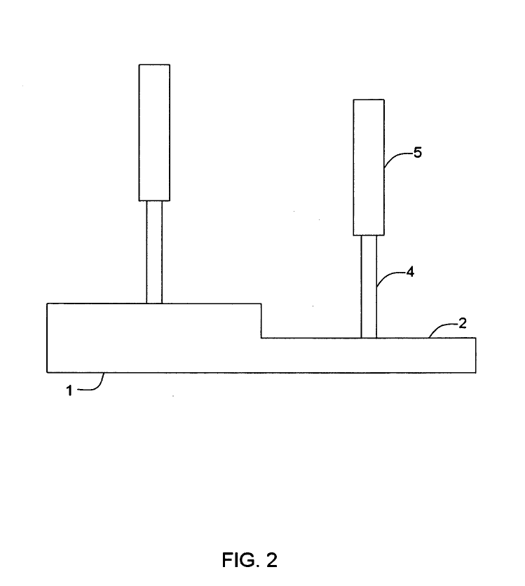

FIG. 2 is a right sided detail view of the motivational, inspirational apparatus showing 2-1, 2-2 the base 10 with two steps, 2-4 posts 12 placed in the top of holes in the base 10 and 2-5 tops 14 mounted on the posts 12. This view exhibits the step make-up of the base 10 1,2 and the posts 12 4 with tops 14 5 on the upper step being slightly higher for better viewing of the words and phrases of the stickers 16 6. Placement of the posts 12 4 and tops 14 5 are positioned equally on the base 10 1,2 avoiding touching of the tops 14 5 when turning 360 degrees.

FIG. 3 is a perspective view of the motivational, inspirational apparatus exhibiting 3-1, 3-2 the base 10 forming two steps, 3-4 the posts 12 inserted into holes in the top of the base 10 1,2, though not limited to six, 3-5 tops 14 not limited to six placed atop the posts 12 4.

FIG. 4 is an exploded perspective view of the motivational, inspirational apparatus further showing the 4-3 holes in the top of the 4-1, 4-2 base 10 for insertion of the 4-4 posts 12 with mounted 4-5 tops 14.

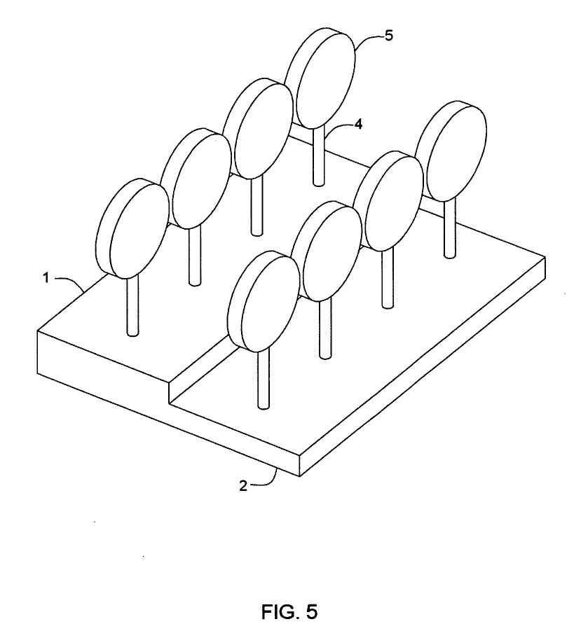

FIG. 5 of the motivational, inspirational apparatus is an example of a plan with more than six posts 12 and tops 14. The apparatus could further have more than one step and more or less than six posts 12 4 and more than six tops 14 5.

In operation, this invention is a personal focusing, centering tool to achieve important goals in one's life. It is not a daily to-do list of chores. It is a motivational, inspirational apparatus designed to keep people on track to do whatever it takes to reach an important life objective or goal. It might be referred to as a goal manager for people to reach goals, obtain life desires like love, diet, jobs, advancing a career position, houses, cars, exercise, creating a new business, project, product, write a book or other intensive life goals.

There are more and more children and adults being diagnosed with Attention Deficit, Hyperactivity Disorder, Obsessive Compulsive Disorder and other stressful nervous syndromes. With the multitude of modern life distractions including, computers, entertainment, televisions, electronic games, cell phones, Internet, theater, driving, travel, parties, work, eating and every other distraction, most people don't accomplish the big dreams they might have or that we've seen in history. It is too easy for people to divert their attention to fun and entertainment rather than follow through with a great idea or objective.

This is a motivational, inspirational apparatus designed to focus people's attention on important life issues, encouraging them to move forward with action towards productive life goals. It is designed to move people to action even when they are not particularly in the mood to act towards an objective. It could be described as an accomplishment tool or achievement tool.

The purpose of the motivational, inspirational apparatus is to be a simple device that guides people in taking the daily action necessary to be successful in the most important areas of their lives and in reaching major life goals. It is intended to move people in leaping walls and barriers they think might be in their way to reaching life objectives.

Every type of device whose intent was remind someone of a task no matter how elaborate, functioned as a to-do list. Reminders associated with these devices included, long daily lists of, taking out the garbage, cleaning a room, grocery lists of milk, eggs, butter, brushing teeth, doing homework, reading, bathing, washing, polishing shoes, watering the lawn, wash hands, make bed, put toys away, set the table, do the dishes, feed the dog, no fighting and even winding a watch. Some of these devices included rewards in the form of stars, ice cream and erasing the task from a list.

This motivational, inspirational apparatus does not address daily tasks, nor is it a grocery list or reminder list of any kind.

The motivational, inspirational apparatus address only the biggest and most important issues in a person's life. Love, money, career, health, relationships, writing books, creating new inventions, acquiring property, houses, cars, or reaching any other serious life goal.

Accordingly, the motivational, inspirational apparatus will be meet the needs and challenges by men, women, children of all ages. Decorative and functional, the apparatus will be used at home, in the workplace, and the classroom.

The motivational, inspirational apparatus has the previously described base 10 1,2 with holes on the top surface that accept evenly placed posts 12 4 in fixed positions. Tops 14 5 are place on the posts 12 4 which can be manually turned 360 degrees. On a surface of the tops 14 5 facing forward, removable stickers 16 6 are placed with specific motivational, inspirational words, phrases and motivational sayings or quotes. One chooses important goals and objectives they would like to accomplish but can't seem to stay focused in following through to completion. Motivational, inspirational stickers 16 6 are placed on a top 5, to visually see and be reminded of the important goal or objective. Each day, some action is to be taken related to every motivational, inspirational sticker on the apparatus. Once at least some action has been made towards an objective or goal, the top 5 can be rotated 180 degrees so that the motivational, inspirational sticker can not be seen for the balance of that day. It is designed to be placed in a conspicuous place to be a frequent reminder. At the end of the day objectives and goals that were not addressed will remain as a reminder of what needs to be done. The following day, all tops 14 5 are rotated forward again and actions for the new day can begin.

It is an object of this motivational, inspirational apparatus to focus one's attention and intentions on; doing what is necessary to reach a specific goal, doing what is necessary to be accomplished in one's life, doing what is necessary to grow spiritually, getting kids responsible for school work, staying on track developing a business, to focus people with ADHD and OCD, to grow healthy relationships with kids, parents siblings and friends, to find a relationship, fight an addiction, improve general health, for weight loss purposes, for achieving new projects or inventions, achieving any commitment to one's self, overcoming life obstacles, successfully handling difficult life problems, and to be grateful for love, peace, harmony and joy in one's life.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A motivational, inspirational apparatus, aka; motivational gizmo for persistent visual prompting in order to accomplish a multiple of important short term and long term personal goals, comprising:
means for a base for support, stability and location of holes for the main feature posts where tops are mounted;
means for insertion into holes in the top of the base and to support the tops. posts are fixed to the base while allowing the tops to rotate 360 degrees, rigidly connected to said means for a base for support, stability and location of holes for the main feature posts where tops are mounted;
means for mounting atop the posts with the ability to turn 360 degrees, and accepting stickers or plaques with motivational words, sayings and messages, rotationally connected to said means for insertion into holes in the top of the base and to support the tops. posts are fixed to the base while allowing the tops to rotate 360 degrees; and
means for placement on the tops to show motivational and inspirational words, phrases, sayings and quotations, removably adhered to said means for mounting atop the posts with the ability to turn 360 degrees, and accepting stickers or plaques with motivational words, sayings and messages.

2. The motivational, inspirational apparatus, aka; motivational gizmo in accordance with claim 1, wherein said means for a base for support, stability and location of holes for the main feature posts where tops are mounted comprises a rectangular or round or oval or square, with one step or two steps or three steps or no steps, rubber or plastic or wood or metal or paper or stone or foam base.

3. The motivational, inspirational apparatus, aka; motivational gizmo in accordance with claim 1, wherein said means for insertion into holes in the top of the base and to support the tops. posts are fixed to the base while allowing the tops to rotate 360 degrees comprises a cylindrical or square or oval or multisided, wood or plastic or metal or stone or paper or rubber, multiple as six or three or four or eight or ten posts.

4. The motivational, inspirational apparatus, aka; motivational gizmo in accordance with claim 1, wherein said means for mounting atop the posts with the ability to turn 360 degrees, and accepting stickers or plaques with motivational words, sayings and messages comprises a round or round and flat or square or oval or shaped as noted in description, paper or wood or plastic or rubber or metal or stone or foam, three inches in diameter or any other size of interest tops.

5. The motivational, inspirational apparatus, aka; motivational gizmo in accordance with claim 1, wherein said means for placement on the tops to show motivational and inspirational words, phrases, sayings and quotations comprises a motivational words, phrases, sayings and quotes, paper or plastic or metal or rubber or foam, sized to fit the tops stickers.

6. A motivational, inspirational apparatus, aka; motivational gizmo for persistent visual prompting in order to accomplish a multiple of important short term and long term personal goals, comprising:
a rectangular or round or oval or square, with one step or two steps or three steps or no steps, rubber or plastic or wood or metal or paper or stone or foam base, for a base for support, stability and location of holes for the main feature posts where tops are mounted;
a cylindrical or square or oval or multisided, wood or plastic or metal or stone or paper or rubber, multiple as six or three or four or eight or ten posts, for insertion into holes in the top of the base and to support the tops. posts are fixed to the base while allowing the tops to rotate 360 degrees, rigidly connected to said base;
a round or round and flat or square or oval or shaped as noted in description, paper or wood or plastic or rubber or metal or stone or foam, three inches in diameter or any other size of interest tops, for mounting atop the posts with the ability to turn 360 degrees, and accepting stickers or plaques with motivational words, sayings and messages, rotationally connected to said posts; and
a motivational words, phrases, sayings and quotes, paper or plastic or metal or rubber or foam, sized to fit the tops stickers, for placement on the tops to show motivational and inspirational words, phrases, sayings and quotations, removably adhered to said tops.

7. A motivational, inspirational apparatus, aka; motivational gizmo for persistent visual prompting in order to accomplish a multiple of important short term and long term personal goals, comprising:
a rectangular or round or oval or square, with one step or two steps or three steps or no steps, rubber or plastic or wood or metal or paper or stone or foam base, for a base for support, stability and location of holes for the main feature posts where tops are mounted;
a cylindrical or square or oval or multisided, wood or plastic or metal or stone or paper or rubber, multiple as six or three or four or eight or ten posts, for insertion into holes in the top of the base and to support the tops. posts are fixed to the base while allowing the tops to rotate 360 degrees, rigidly connected to said base;
a round or round and flat or square or oval or shaped as noted in description, paper or wood or plastic or rubber or metal or stone or foam, three inches in diameter or any other size of interest tops, for mounting atop the posts with the ability to turn 360 degrees, and accepting stickers or plaques with motivational words, sayings and messages, rotationally connected to said posts; and
a motivational words, phrases, sayings and quotes, paper or plastic or metal or rubber or foam, sized to fit the tops stickers, for placement on the tops to show motivational and inspirational words, phrases, sayings and quotations, removably adhered to said tops.
